(19) United States
(12) Patent Application Publication
(10) Pub. No.: US 2015/0242886 A1
(43) Pub. Date: Aug. 27, 2015

(54) AD IMPRESSION AVAILABILITY AND ASSOCIATED ADJUSTMENT VALUES

(71) Applicant: Yahoo! Inc., Sunnyvale, CA (US)

(72) Inventors: Supreeth Rao, Sunnyvale, CA (US); Sunil Kumar Gupta, Sunnyvale, CA (US)

(73) Assignee: YAHOO! INC., Sunnyvale, CA (US)

(21) Appl. No.: 14/189,794

(22) Filed: Feb. 25, 2014

(51) Int. Cl. G06Q 30/02

(52) U.S. Cl. CPC G06Q 30/0246

(57) ABSTRACT

A system can provide ad impression availability for one or more audience segments or at least part of an ad campaign. The system can also adjust such ad impression availability at different stages of ad production, booking, and delivery, such as at a time immediately prior to serving an ad impression or at a time of presenting ad impression availability to an advertiser at booking of ad impressions. Adjustments can be based on attributes of the audience segment(s) or the at least part of an ad campaign. For example, ad impression availability can be adjusted according to breadth and/or popularity of the segment(s) or the at least part of an ad campaign.

### BACKGROUND

This application relates to determining ad impression availability for an audience segment, a combination of audience segments, or an ad campaign. This application also relates to adjustment values for modifying ad impression availability.

Contemporary Data Management Platforms (DMPs) are computer information systems that can consolidate retrieval, integration, and management of data (whether structured or unstructured) from various types of data sources. DMPs are commonly used by online service providers, such as online ad service providers. For online ad service providers, DMPs can provide consolidated development and productions environments for online advertising.

A DMP can be coupled with or include an analytics system that can analyze the data collected by a DMP. For an advertiser or a service provider, information on the delivery of ads can be invaluable and can influence booking and pricing of ads at various stages of production and delivery. For example, statistics may be collected and analyzed for audience segments or ad campaigns, and such statistics may be used to target advertising.

In a DMP, not all audience segments are treated equally, and statistics on segment differences can be utilized to improve cost effectiveness in an online ad marketplace. Some segments are more generic and receive a greater amount of bids and audience activity; and some segments are niche and receive a lesser amount of bids and audience activity. The same can hold true for ad campaigns. Given that different segments and campaigns have disparate marketplace worth, it is advantageous for service providers to influence bidding and pricing to correlate with the value of target audiences. By providing information that accurately reflects the value of a target audience or segment, bidding and pricing in an online ad marketplace can be cost effective for advertisers and service providers. One way to influence cost effective bidding and pricing of ads is to use historical data on ad impressions delivered and estimated analytics for future delivery of ad impressions.

### BRIEF DESCRIPTION OF THE DRAWINGS

The systems and methods may be better understood with reference to the following drawings and description. Non-limiting and non-exhaustive examples are described with reference to the following drawings. The components in the drawings are not necessarily to scale; emphasis instead is being placed upon illustrating the principles of the system. In the drawings, like referenced numerals designate corresponding parts throughout the different views.

FIG. 1 illustrates a block diagram of an example information system that includes example devices of a network that can communicatively couple with an example system that can provide ad impression availability.

FIG. 2 illustrates displayed ad items and content items of example screens rendered by client-side applications (including a web browser).

FIG. 3 illustrates example graphical elements that may appear in example screens rendered by client-side applications, such as the screens in FIG. 2.

FIG. 4 illustrates a block diagram of the example information system of FIG. 1 (information system 100 of FIG. 1) interacting with an example system that can provide ad impression availability (such as availability server 116 of FIG. 1 and FIG. 4).

FIGS. 5 and 6 are block diagrams of example electronic devices that can implement aspects of and related to example systems that can provide ad impression availability (such as advertiser client device 401a and audience client device 401b of FIG. 4 and the availability server 116).

### DETAILED DESCRIPTION

Subject matter will now be described more fully hereinafter with reference to the accompanying drawings, which form a part hereof, and which show, by way of illustration, specific examples. Subject matter may, however, can be embodied in a variety of different forms and, therefore, covered or claimed subject matter is intended to be construed as not being limited to examples set forth herein; examples are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

### Overview of Ad Impression Availability and Associated Adjustment Values

In evaluating the worth of a target audience, an amount of ad impressions delivered to that audience within a given time period (“ad impressions delivery rate”) can be a telling measurement. Also, an estimated amount of ad impressions available that are likely to be delivered to the target audience within a given time period (“ad impressions available for delivery rate”) can be helpful in determining that target audience's market value. The ad impressions delivery rate or ad impressions available for delivery rate, per audience segment, combination of segments, ad campaign, or part of an ad campaign can influence advertisers' bidding on targeted ads and can also influence pricing of ads at different stages of ad production and delivery (such as the period of serving ad impressions). With respect to the life of an ad campaign, part of an ad campaign, or a target audience, such as a target audience segment or target combination of segments, ad impressions delivered and estimated ad impressions available for delivery can be useful measurements on influencing bidding at booking of ad impressions and pricing at impression serve time.

Ad impression availability can include the ad impression available for delivery rate, an estimated amount of ad impressions available for a life of a segment or a combination of segments, or an estimated amount of ad impressions available for an ad campaign or a part of an ad campaign. A life of a segment, a combination of segments, or at least a part of an ad campaign can be an estimated amount of time that such an audience or marketing plan may exist in an online marketplace.

Ad impressions delivered can include a historical ad impressions delivery rate for a segment, a combination of segments, or at least a part of an ad campaign. Ad impressions delivered can also include a historical amount of ad impressions delivered for a segment, a combination of segments, or at least a part of an ad campaign.

An audience segment can be a group of ad audience members that share one or more demographics, psychographics, interests, or preferences. A demographic is a quantifiable statistic of a given population. A demographic can relate to a shared gender, age, ethnicity, knowledge of language, disability, financial status, employment status, mobility, and location. A psychographic is another type of quantifiable statistic of a given population, which can relate to personality traits, personal values, attitudes, and personal routines. Shared preferences may include preferred device or medium to receive ads and content, preferred telecommunications carrier, and preferred formatting and timing of certain content. Segments may even be arbitrary. Audience segments can be determined from shared web browsing behaviors, such as shared visited websites, searches, clicks, and dayparting information. Segments can also be determined from offline activities.

A combination of segments can be a combination of related segments. Relationships can be determined by a correlation between segments exceeding a correlation threshold. A correlation between segments can be determined by various correlation calculations beyond the scope of this application.

An ad campaign can be a strategy or plan for delivering ads, such as online ads. Ad campaigns can include ad targeting of one or more segments and combinations of segments. An ad campaign can include a life, which can include various time periods of various strategies for ad delivery. Each disparate time period within a campaign may include ad targeting of different audience segments.

Described herein are systems, products, and methods for providing ad impression availability for an audience segment, a combination of audience segments, or at least part of an ad campaign. These systems, products, and methods can adjust impression availability for the audience segment, the combination of audience segments, or the at least part of an ad campaign, at different stages of ad production and delivery, and can also present ad impression availability to an advertiser at booking. Adjustments can be based on attributes of the audience segment, the combination of audience segments, or the at least part of an ad campaign.

Ad impression availability can be determined or adjusted according to several factors. In an example, ad impression availability adjustments can be based on attributes of the audience segment, the combination of audience segments, or the at least part of an ad campaign. Also, for example, the determination of whether to serve an ad or not to serve an ad to an audience member of the audience segment, the combination of audience segments, or the at least part of an ad campaign, can depend on an adjusted impression availability for such an audience member.

Ad impression availability can be adjusted according to breadth and/or popularity of the audience segment, the combination of audience segments, or the at least part of an ad campaign. Two indices can represent such breadth and/or popularity, for example. Niche segment correction factor (“NSCF”) index can represent niche of the audience segment, the combination of audience segments, or the at least part of an ad campaign. Segment contention index (“SCI”) can represent popularity of the audience segment, the combination of audience segments, or the at least part of an ad campaign.

### DESCRIPTION OF THE DRAWINGS

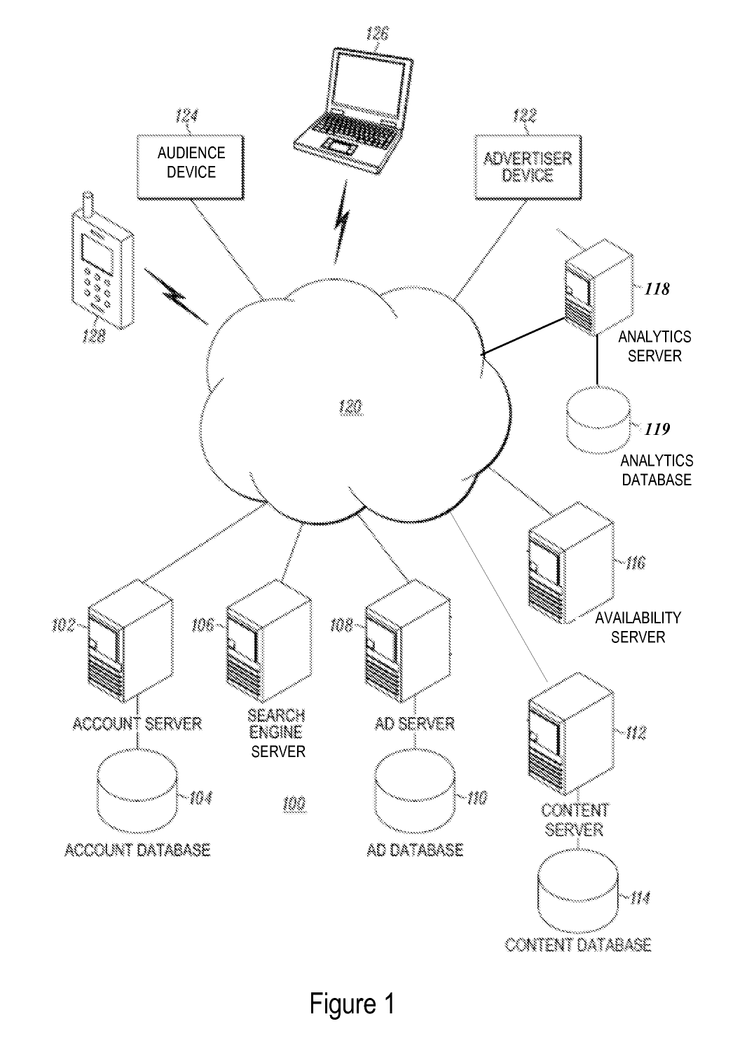

FIG. 1 illustrates a block diagram of an example information system that includes example devices of a network that can communicatively couple with an example system that provides ad impression availability for ad campaigns and/or audience segments. The information system 100 in the example of FIG. 1 includes an account server 102, an account database 104, a search engine server 106, an ad server 108, an ad database 110, a content database 114, a content server 112, an availability server 116, an analytics server 118, and an analytics database 119. The aforementioned servers and databases can be communicatively coupled over a network 120.

The information system 100 may be accessible over the network 120 by advertiser devices, such as an advertiser client device 122 and by audience devices, such as an audience client device 124. An audience device can be a user device that presents online advertisements, such as a device that presents online advertisements to an audience member. In various examples of such an online information system, users may search for and obtain content from sources over the network 120, such as obtaining content from the search engine server 106, the ad server 108, the ad database 110, the content server 112, and the content database 114. Advertisers may provide advertisements for placement on electronic properties, such as web pages, and other communications sent over the network to audience devices, such as the audience client device 124. The online information system can be deployed and operated by an online services provider, such as Yahoo! Inc.

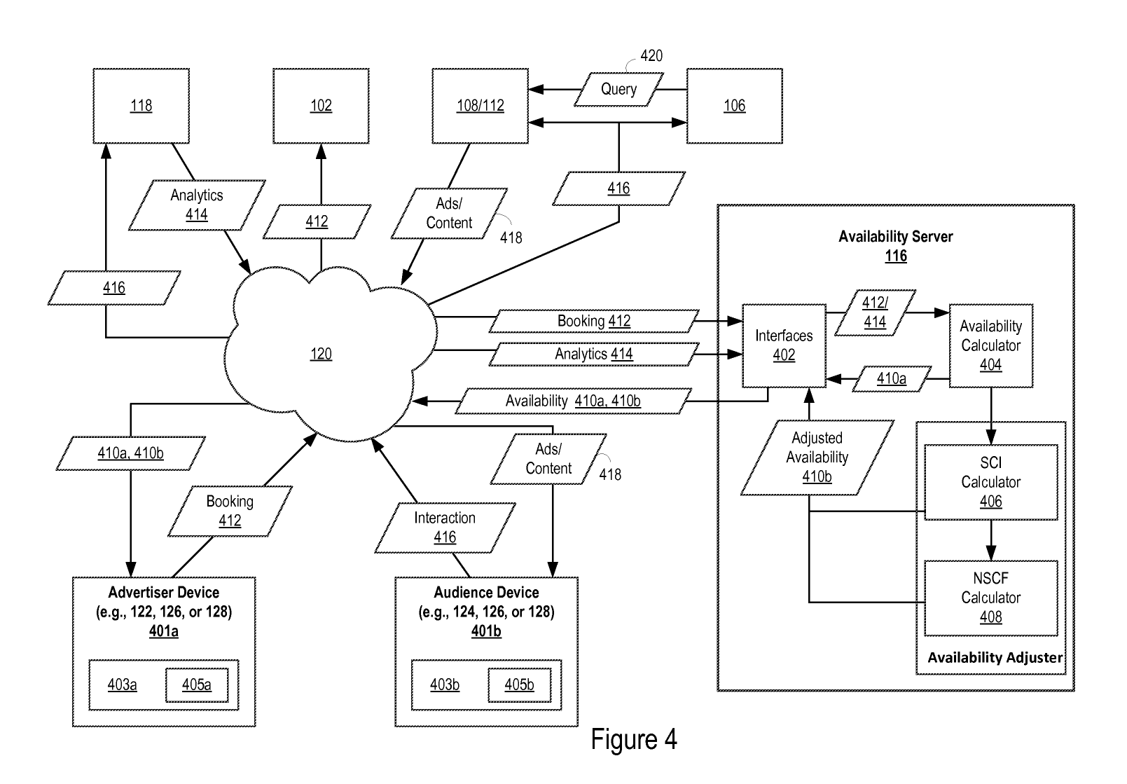

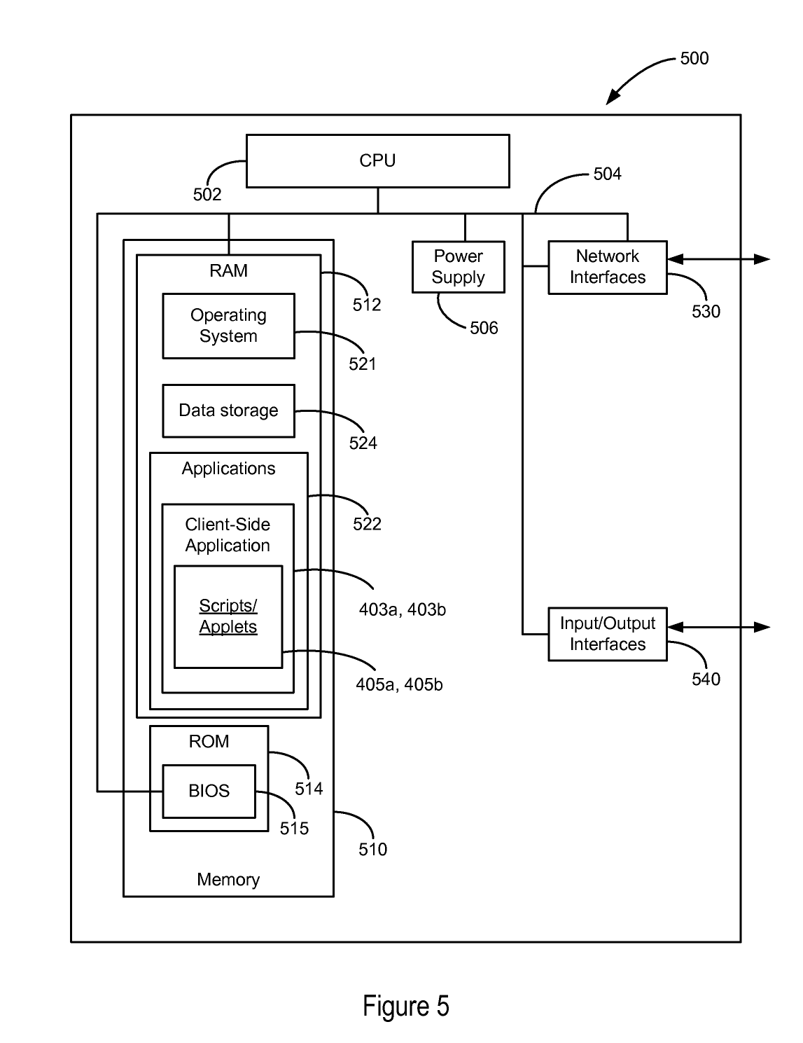

The account server 102 stores account information for advertisers. The account server 102 is in data communication with the account database 104. Account information may include database records associated with each respective advertiser. Suitable information may be stored, maintained, updated and read from the account database 104 by the account server 102. Examples include advertiser identification information, advertiser security information, such as passwords and other security credentials, account balance information, and information related to content associated with their ads, and user interactions associated with their ads and associated content. Also, examples include analytics data related to their ads and associated content and user interactions with the aforementioned. In an example, the analytics data may be in the form of one or more sketches, such as in the form of a sketch per audience segment, segment combination, or at least part of a campaign. The account information may include ad booking information (such as ad booking data 412 of FIG. 4), and such booking information may be communicated to the availability server 116 for processing. This booking information can be used as input for determining ad impression availability. Also, ad impression availability information (such as impression availability data 410a and 410b of FIG. 4) can be fed back to the account server 102 or a user interface of the account server (such as client-side application 403a of FIG. 4), and influence the booking of ads.

The account server 102 may be implemented using a suitable device. The account server 102 may be implemented as a single server, a plurality of servers, or another type of computing device known in the art. Access to the account server 102 can be accomplished through a firewall that protects the account management programs and the account information from external tampering. Additional security may be provided via enhancements to the standard communications protocols, such as Secure HTTP (HTTPS) or the Secure Sockets Layer (SSL). Such security may be applied to any of the servers of FIG. 1, for example.

The account server 102 may provide an advertiser front end to simplify the process of accessing the account information of an advertiser (such as the client-side application 403a). The advertiser front end may be a program, application, or software routine that forms a user interface. In a particular example, the advertiser front end is accessible as a website with electronic properties that an accessing advertiser may view on an advertiser device, such as the advertiser client device 122. The advertiser may view and edit account data and advertisement data, such as ad booking data, using the advertiser front end. After editing the advertising data, the account data may then be saved to the account database 104.

Also, audience analytics, impressions delivered, impression availability, and segments may be viewed in real time using the advertiser front end. The advertiser front end may be a client-side application, such as the client-side application 403a running on the advertiser client device 401a. A script and/or applet (such as a script and/or applet 405a of FIG. 4) may be a part of this front end and may render access points for retrieval of the audience analytics, impressions delivered, impression availability, and segments. In an example, this front end may include a graphical display of fields for selecting an audience segment, segment combination, or at least part of a campaign. The front end, via the script and/or applet, can request the audience analytics, impressions delivered, and impression availability for the audience segment, segment combination, or at least part of a campaign. The information can then be displayed, such as displayed according to the script and/or applet.

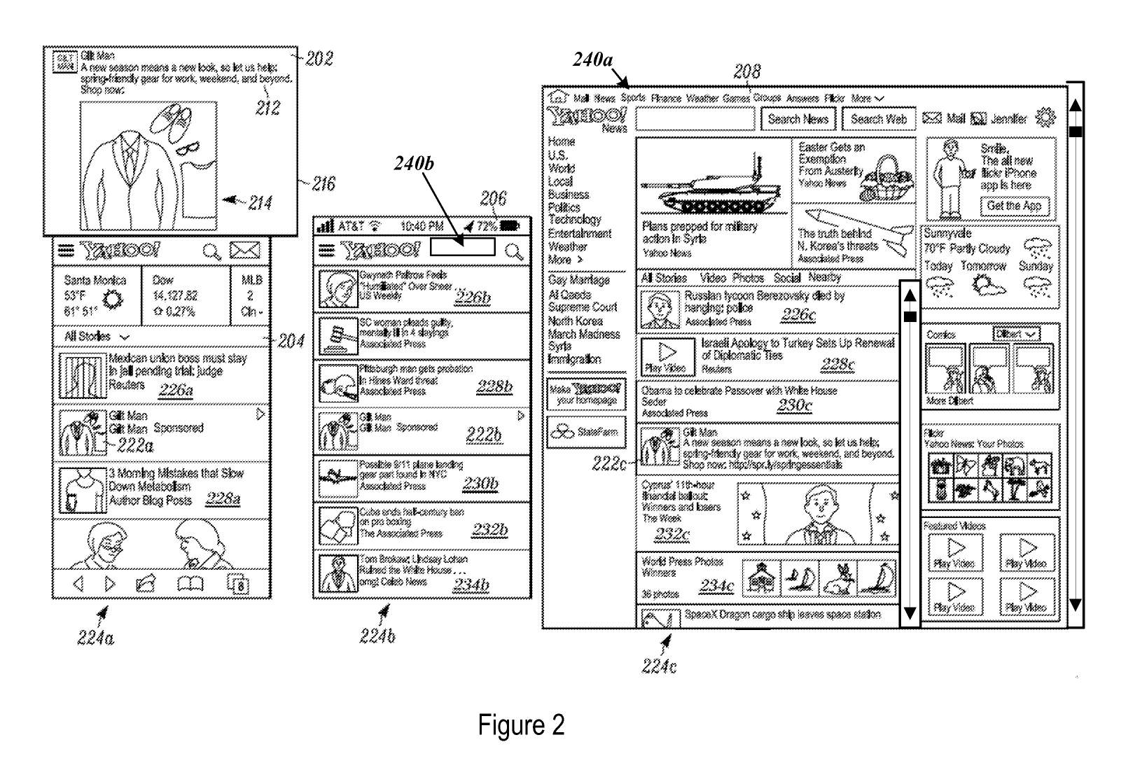

The search engine server 106 may be one or more servers. Alternatively, the search engine server 106 may be a computer program, instructions, or software code stored on a computer-readable storage medium that runs on one or more processors of one or more servers. The search engine server 106 may be accessed by audience devices, such as the audience client device 124 operated by an audience member over the network 120. Access may be through graphical access points. For example, query entry box 240b of FIG. 2 may be an access point for the user to submit a search query to the search engine server 106. Search queries submitted or other user interactions with the search engine server 106 can be logged in data logs (such as interaction data 416 of FIG. 4), and such logs may be communicated to the analytics server 118 for processing. After processing, the analytics server 118 can output corresponding analytics data (such as analytics data 414 of FIG. 4) to be served to the availability server 116 for determining impression availability.

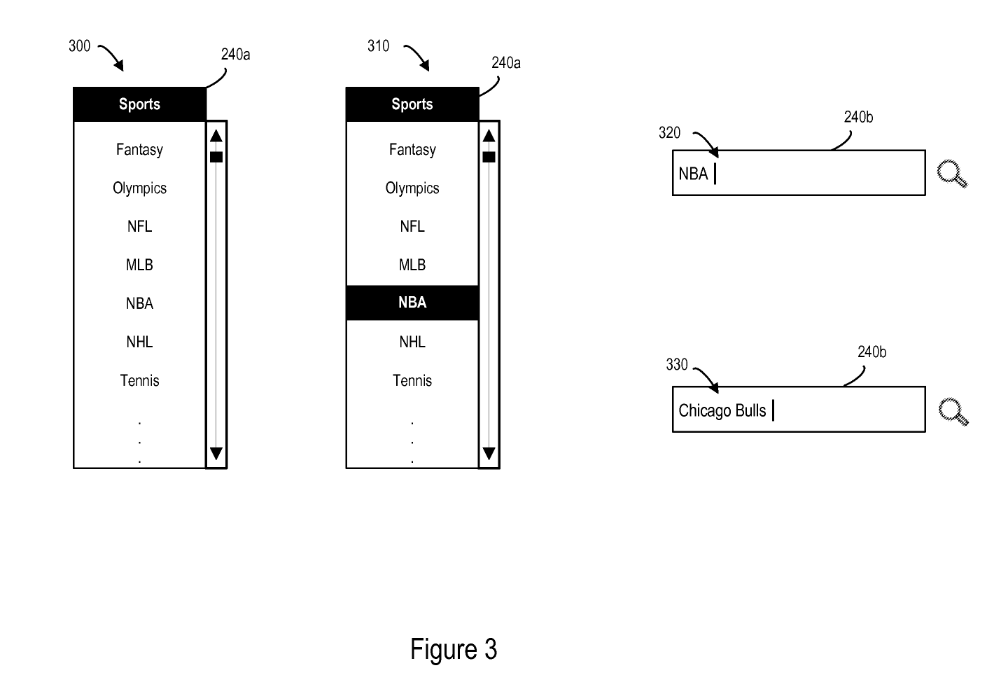

FIG. 3 illustrates two menu selections 300 and 310 entered at the menu anchor 240a of FIG. 2. The menu selection 300 includes the text “Sports” that may match an audience segment title “Sports”. The menu selection 310 includes the text “NBA” that may match an audience segment title “NBA”. Segment “NBA” may be a sub-segment of basketball and/or sports, for example. FIG. 3 also illustrates two search query entries 320 and 330 entered into the query entry box 240b of FIG. 2. The search query entry 320 includes the text “NBA” that may match an audience segment title “NBA”. Segment “NBA” may be a sub-segment of basketball and/or sports, for example. The search query entry 330 includes the text “Chicago Bulls” that may match an audience segment title “Chicago Bulls”. Segment “Chicago Bulls” may be a sub-segment of NBA, basketball and/or sports, for example. Alternatively, Chicago Bulls may not be a sub-segment of NBA, but may be associated with NBA, basketball and/or sports in another manner. Also, such terms may be correlated, and such correlations may affect determination of corresponding impression availability information. The strength of a correlation may also affect such a determination, and a correlation between terms may be required to exceed a threshold to be considered in the determination of impression availability information. The hierarchy of segments and its influence on determining and adjusting impressions availability is described below.

The audience client device 124 communicates a user query to the search engine server 106, such as via the interaction data 416. For example, a query entered into a query entry box, such as the query entry box 240b, can be communicated to the search engine server 106. The search engine server 106 locates matching information using a suitable protocol or algorithm and returns information to the audience client device 124, such as in the form of ads or content. As depicted in FIG. 4, the search engine server 106 may receive the interaction data 416 from an audience device, send a corresponding query 420 to the ad server 108 and/or the content server 112, and the ad server 108 and/or the content server 112 may serve corresponding ads and/or content 418. The information inputted and/or outputted by these devices may be logged in data logs and communicated to the analytics server 118 for processing, via the network 120.

The search engine server 106 may be designed to help users and potential audience members find information located on the Internet or an intranet. In an example, the search engine server 106 may also provide to the audience client device 124 over the network 120 an electronic property, such as a web page, with content, including search results, information matching the context of a user inquiry, links to other network destinations, or information and files of information of interest to a user operating the audience client device 124, as well as a stream or web page of content items and advertisement items selected for display to the user. This information provided by the search engine server 106 may also be logged, and such logs may be communicated to the analytics server 118 for processing. Once processed into corresponding analytics data (such as the analytics data 414), such data can be input for determining ad impression availability.

The search engine server 106 may enable a device, such as the advertiser client device 122, the audience client device 124, or another type of client device, to search for files of interest using a search query. Typically, the search engine server 106 may be accessed by a client device via servers or directly over the network 120. The search engine server 106 may include a crawler component, an indexer component, an index storage component, a search component, a ranking component, a cache, a profile storage component, a logon component, a profile builder, and application program interfaces (APIs). The search engine server 106 may be deployed in a distributed manner, such as via a set of distributed servers, for example. Components may be duplicated within a network, such as for redundancy or better access.

The ad server 108 operates to serve advertisements to audience devices, such as the audience client device 124. An advertisement may include text data, graphic data, image data, video data, or audio data. Advertisements may also include data defining advertisement information that may be of interest to a user of an audience device. The advertisements may also include respective audience targeting information or ad campaign information, such as information on audience segments and segment combinations. An advertisement may further include data defining links to other online properties reachable through the network 120. The aforementioned audience targeting information and the other data associated an ad may be logged in data logs and such logs may be communicated to the analytics server 118 for processing. Once processed into corresponding analytics data (such as the analytics data 414), such data can be input for determining ad impression availability.

For online service providers, advertisements may be displayed on electronic properties resulting from a user-defined search based, at least in part, upon search terms. Advertising may be beneficial to users, advertisers or web portals if displayed advertisements are relevant to audience segments, segment combinations, or at least parts of campaigns. Thus, a variety of techniques have been developed to determine corresponding audience segments or to subsequently target relevant advertising to audience members of such segments. For example user interests, user intentions, and targeting data related to segments or campaigns may be may be logged in data logs and such logs may be communicated to the analytics server 118 for processing. Once processed into corresponding analytics data (such as the analytics data 414), such data can be input for determining ad impression availability.

One approach to presenting targeted advertisements includes employing demographic characteristics (such as age, income, sex, occupation, etc.) for predicting user behavior, such as by group. Advertisements may be presented to users in a targeted audience based, at least in part, upon predicted user behavior. The aforementioned targeting data, such as demographic data and psychographic data, may be logged in data logs and such logs may be communicated to the analytics server 118 for processing. Once processed into corresponding analytics data (such as the analytics data 414), such data can be input for determining ad impression availability.

Another approach includes profile-type ad targeting. In this approach, user profiles specific to a user may be generated to model user behavior, for example, by tracking a user's path through a website or network of sites, and compiling a profile based, at least in part, on pages or advertisements ultimately delivered. A correlation may be identified, such as for user purchases, for example. An identified correlation may be used to target potential purchasers by targeting content or advertisements to particular users. The aforementioned profile-type targeting data may be logged in data logs and such logs may be communicated to the analytics server 118 for processing. Once processed into corresponding analytics data (such as the analytics data 414), such data can be input for determining ad impression availability.

Yet another approach includes targeting based on content of an electronic property requested by a user. Advertisements may be placed on an electronic property or in association with other content that is related to the subject of the advertisements. The relationship between the content and the advertisement may be determined in a suitable manner. The overall theme of a particular electronic property may be ascertained, for example, by analyzing the content presented therein. Moreover, techniques have been developed for displaying advertisements geared to the particular section of the article currently being viewed by the user. Accordingly, an advertisement may be selected by matching keywords, and/or phrases within the advertisement and the electronic property. The aforementioned targeting data (which may include user interaction data such as the interaction data 416) may be logged in data logs and such logs may be communicated to the analytics server 118 for processing. Once processed into corresponding analytics data (such as the analytics data 414), such data can be input for determining ad impression availability.

The ad server 108 includes logic and data operative to format the advertisement data for communication to a user device, such as an audience member device. The ad server 108 is in data communication with the ad database 110. The ad database 110 stores information, including data defining advertisements, to be served to user devices. This advertisement data may be stored in the ad database 110 by another data processing device or by an advertiser. The advertising data may include data defining advertisement creatives and bid amounts for respective advertisements and/or audience segments. The aforementioned ad formatting and pricing data may be logged in data logs and such logs may be communicated to the analytics server 118 for processing. Once processed into corresponding analytics data (such as the analytics data 414), such data can be input for determining ad impression availability.

The advertising data may be formatted to an advertising item that may be included in a stream of content items and advertising items provided to an audience device. The formatted advertising items can be specified by appearance, size, shape, text formatting, graphics formatting and included information, which may be standardized to provide a consistent look for advertising items in the stream. The aforementioned advertising data may be logged in data logs and such logs may be communicated to the analytics server 118 for processing. Once processed into corresponding analytics data (such as the analytics data 414), such data can be input for determining ad impression availability.

Further, the ad server 108 is in data communication with the network 120. The ad server 108 communicates ad data and other information to devices over the network 120. This information may include advertisement data communicated to an audience device. This information may also include advertisement data and other information communicated with an advertiser device, such as the advertiser client device 122. An advertiser operating an advertiser device may access the ad server 108 over the network to access information, including advertisement data. This access may include developing advertisement creatives, editing advertisement data, deleting advertisement data, setting and adjusting bid amounts and other activities. The ad server 108 then provides the ad items to other network devices, such as the availability server 116, the analytics server 118, and/or the account server 102, for classification of the ad items (such as associating the ad items with audience segments, segment combinations, or at least parts of campaigns). This information can be input for the determining ad impression availability.

The ad server 108 may provide an advertiser front end to simplify the process of accessing the advertising data of an advertiser. The advertiser front end may be a program, application or software routine that forms a user interface. In one particular example, the advertiser front end is accessible as a website with electronic properties that an accessing advertiser may view on the advertiser device. The advertiser may view and edit advertising data using the advertiser front end. After editing the advertising data, the advertising data may then be saved to the ad database 110 for subsequent communication in advertisements to an audience device.

The ad server 108 may be one or more servers. Alternatively, the ad server 108 may be a computer program, instructions, and/or software code stored on a computer-readable storage medium that runs on one or more processors of one or more servers. The content server 112 may access information about content items either from the content database 114 or from another location accessible over the network 120. The content server 112 communicates data defining content items and other information to devices over the network 120.

The information about content items may also include content data and other information communicated by a content provider operating a content provider device, such as respective audience segment information. A content provider operating a content provider device may access the content server 112 over the network 120 to access information, including the respective segment information. This access may be for developing content items, editing content items, deleting content items, setting and adjusting bid amounts and other activities, such as associating content items with audience segments, segment combinations, or at least parts of campaigns. A content provider operating a content provider device may also access the availability server 116 over the network 120 to access analytics data and/or impression availability. Such analytics may help focus developing content items, editing content items, deleting content items, setting and adjusting bid amounts, and activities related to distribution of the content.

The content server 112 may provide a content provider front end to simplify the process of accessing the content data of a content provider. The content provider front end may be a program, application or software routine that forms a user interface. In a particular example, the content provider front end is accessible as a website with electronic properties that an accessing content provider may view on the content provider device. The content provider may view and edit content data using the content provider front end. After editing the content data, such as at the content server 112 or another source of content, the content data may then be saved to the content database 114 for subsequent communication to other devices in the network 120.

The content provider front end may be a client-side application, such as a client-side application 403a or 403b running on the advertiser client device 401a or the audience client device 401b, respectively. A script and/or applet, such as the script and/or applet 405a or 405b, may be a part of this front end and may render access points for retrieval of impression availability data (such as the impression availability data 410a and 410b), and the script and/or applet may manage the retrieval of the impression availability data. In an example, this front end may include a graphical display of fields for selecting audience segments, segment combinations, or at least parts of campaigns. Then this front end, via the script and/or applet, can request the impression availability for the audience segments, segment combinations, or at least parts of campaigns. The analytics can then be displayed, such as displayed according to the script and/or applet.

The content server 112 includes logic and data operative to format content data for communication to the audience device. The content server 112 can provide content items or links to such items to the analytics server 118 or the availability server to associate with audience segments and impression availability data. For example, content items and links may be matched to such data. The matching may be complex and may be based on historical information related to the audience segments and impression availability. Techniques for matching content items and links to the audience segments and impression availability are numerous and beyond the scope of this application.

The content data may be formatted to a content item that may be included in a stream of content items and advertisement items provided to an audience device. The formatted content items can be specified by appearance, size, shape, text formatting, graphics formatting and included information, which may be standardized to provide a consistent look for content items in the stream. The formatting of content data may be logged in data logs and such logs may be communicated to the analytics server 118 for processing. Once processed into corresponding analytics data (such as the analytics data 414), such data can be input for determining ad impression availability.

In an example, the content items may have an associated bid amount that may be used for ranking or positioning the content items in a stream of items presented to an audience device. In other examples, the content items do not include a bid amount, or the bid amount is not used for ranking the content items. Such content items may be considered non-revenue generating items. The bid amounts and other related information may be logged in data logs and such logs may be communicated to the analytics server 118 for processing. Once processed into corresponding analytics data (such as the analytics data 414), such data can be input for determining ad impression availability.

The aforementioned servers and databases may be implemented through a computing device. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally, a server may include a central processing unit and memory. A server may also include a mass storage device, a power supply, wired and wireless network interfaces, input/output interfaces, and/or an operating system, such as Windows Server, Mac OS X, UNIX, Linux, FreeBSD, or the like.

The aforementioned servers and databases may be implemented as online server systems or may be in communication with online server systems. An online server system may include a device that includes a configuration to provide data via a network to another device including in response to received requests for page views or other forms of content delivery. An online server system may, for example, host a site, such as a social networking site, examples of which may include, without limitation, Flicker, Twitter, Facebook, LinkedIn, or a personal user site (such as a blog, vlog, online dating site, etc.). An online server system may also host a variety of other sites, including, but not limited to business sites, educational sites, dictionary sites, encyclopedia sites, wikis, financial sites, government sites, etc.

An online server system may further provide a variety of services that may include web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as an online server system include desktop computers, multiprocessor systems, microprocessor-type or programmable consumer electronics, etc. The online server system may or may not be under common ownership or control with the servers and databases described herein.

The network 120 may include a data communication network or a combination of networks. A network may couple devices so that communications may be exchanged, such as between a server and a client device or other types of devices, including between wireless devices coupled via a wireless network, for example. A network may also include mass storage, such as a network attached storage (NAS), a storage area network (SAN), or other forms of computer or machine readable media, for example. A network may include the Internet, local area networks (LANs), wide area networks (WANs), wire-line type connections, wireless type connections, or any combination thereof. Likewise, sub-networks, such as may employ differing architectures or may be compliant or compatible with differing protocols, may interoperate within a larger network, such as the network 120.

Various types of devices may be made available to provide an interoperable capability for differing architectures or protocols. For example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links, including satellite links, or other communication links or channels, such as may be known to those skilled in the art. Furthermore, a computing device or other related electronic devices may be remotely coupled to a network, such as via a telephone line or link, for example.

The advertiser client device 122 includes a data processing device that may access the information system 100 over the network 120. The advertiser client device 122 is operative to interact over the network 120 with any of the servers or databases described herein. The advertiser client device 122 may implement a client-side application for viewing electronic properties and submitting user requests. The advertiser client device 122 may communicate data to the information system 100, including data defining electronic properties and other information. The advertiser client device 122 may receive communications from the information system 100, including data defining electronic properties and advertising creatives. The aforementioned interactions and information may be logged in data logs and such logs may be communicated to the analytics server 118 for processing. Once processed into corresponding analytics data (such as the analytics data 414), such data can be input for determining ad impression availability.

In an example, content providers may access the information system 100 with content provider devices that are generally analogous to the advertiser devices in structure and function. The content provider devices provide access to content data in the content database 114, for example.

The audience client device 124 includes a data processing device that may access the information system 100 over the network 120. The audience client device 124 is operative to interact over the network 120 with the search engine server 106, the ad server 108, the content server 112, the availability server 116, and the analytics server 118. The audience client device 124 may implement a client-side application for viewing electronic content and submitting user requests. A user operating the audience client device 124 may enter a search request and communicate the search request to the information system 100. The search request is processed by the search engine and search results are returned to the audience client device 124. The aforementioned interactions and information may be logged in data logs and such logs may be communicated to the analytics server 118 for processing. Once processed into corresponding analytics data (such as the analytics data 414), such data can be input for determining ad impression availability.

In other examples, a user of the audience client device 124 may request data, such as a page of information from the online information system 100. The data instead may be provided in another environment, such as a native mobile application, TV application, or an audio application. The online information system 100 may provide the data or re-direct the browser to another source of the data. In addition, the ad server may select advertisements from the ad database 110 and include data defining the advertisements in the provided data to the audience client device 124. The aforementioned interactions and information may be logged in data logs and such logs may be communicated to the analytics server 118 for processing. Once processed into corresponding analytics data (such as the analytics data 414), such data can be input for determining ad impression availability.

The advertiser client device 122 and the audience client device 124 operate as a client device when accessing information on the information system 100. A client device, such as the advertiser client device 122 and the audience client device 124 may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. In the example of FIG. 1, both laptop computer 126 and smartphone 128, which can be client devices, may be operated as either an advertiser device or an audience device.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include a physical or virtual keyboard, mass storage, an accelerometer, a gyroscope, global positioning system (GPS) or other location-identifying type capability, or a display with a high degree of functionality, such as a touch-sensitive color 2D or 3D display, for example.

A client device, such as the advertiser client device 122 and the audience client device 124, may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally or remotely stored or streamed video, or games. The foregoing is provided to illustrate that claimed subject matter is intended to include a wide range of possible features or capabilities. At least some of the features, capabilities, and interactions with the aforementioned may be logged in data logs and such logs may be communicated to the analytics server 118 for processing. Once processed into corresponding analytics data (such as the analytics data 414), such data can be input for determining ad impression availability.

Also, the disclosed methods and systems may be implemented at least partially in a cloud-computing environment, at least partially in a server, at least partially in a client device, or in a combination thereof.

FIG. 2 illustrates displayed ad items and content items of example screens rendered by client-side applications. The content items and ad items displayed may be provided by the search engine server 106, the ad server 108, or the content server 112. For example, menus of content may be provided dynamically by a content taxonomy stored on one of the aforementioned servers. In such an example, menu items may be strictly associated with a taxonomy or loosely associated with the taxonomy. Also, the audience segments may be strictly or loosely associated the taxonomy. Menus of content may be opened by rolling over or clicking on menu anchors, such as the menu anchor labeled “sports” 240a. User interactions with the menu anchor 240a, the query entry box 240b, or another tracked aspect of the screens can be tracked and logged in data logs (such as the interaction data 416), and the logs may be communicated to the analytics server 118 for processing. Once processed into corresponding analytics data (such as the analytics data 414), such data can be input for determining ad impression availability.

In FIG. 2, a display ad 202 is illustrated as displayed on a variety of displays including a mobile web device display 204, a mobile application display 206 and a personal computer display 208. The mobile web device display 204 may be shown on the display screen of a mobile handheld device, such as a smartphone. The mobile application display 206 may be shown on the display screen of a portable device, such as a tablet computer. The personal computer display 208 may be displayed on the display screen of a personal computer (PC).

The display ad 202 is shown in FIG. 2 formatted for display on an audience device but not as part of a stream to illustrate an example of the contents of such a display ad. The display ad 202 includes text 212, graphic images 214 and a defined boundary 216. The display ad 202 can be developed by an advertiser for placement on an electronic property, such as a web page, sent to an audience device operated by a user. The display ad 202 may be placed in a wide variety of locations on the electronic property. The defined boundary 216 and the shape of the display ad can be matched to a space available on an electronic property. If the space available has the wrong shape or size, the display ad 202 may not be useable. Such reformatting may be logged in data logs and such logs may be communicated to the analytics server 118 for processing. Once processed into corresponding analytics data (such as the analytics data 414), such data can be input for determining ad impression availability.

In these examples, the display ad is shown as a part of streams 224a, 224b, and 224c. The streams 224a, 224b, and 224c include a sequence of items displayed, one item after another, for example, down an electronic property viewed on the mobile web device display 204, the mobile application display 206 and the personal computer display 208. The streams 224a, 224b, and 224c may include various types of items. In the illustrated example, the streams 224a, 224b, and 224c include content items and advertising items. For example, stream 224a includes content items 226a and 228a along with advertising item 222a; stream 224b includes content items 226b, 228b, 230b, 232b, 234b and advertising item 222b; and stream 224c includes content items 226c, 228c, 230c, 232c and 234c and advertising item 222c. With respect to FIG. 2, the content items can be items published by non-advertisers. However, these content items may include advertising components. Each of the streams 224a, 224b, and 224c may include a number of content items and advertising items.

In an example, the streams 224a, 224b, and 224c may be arranged to appear to the user to be an endless sequence of items, so that as a user, of an audience device on which one of the streams 224a, 224b, or 224c is displayed, scrolls the display, a seemingly endless sequence of items appears in the displayed stream. The scrolling can occur via the scroll bars, for example, or by other known manipulations, such as a user dragging his or her finger downward or upward over a touch screen displaying the streams 224a, 224b, or 224c. To enhance the apparent endless sequence of items so that the items display quicker from manipulations by the user, the items can be cached by a local cache and/or a remote cache associated with the client-side application or the page view.

The content items positioned in any of streams 224a, 224b, and 224c may include news items, business-related items, sports-related items, etc. Further, in addition to textual or graphical content, the content items of a stream may include other data as well, such as audio and video data or applications. Each content item may include text, graphics, other data, and a link to additional information. Clicking or otherwise selecting the link re-directs the browser on the client device to an electronic property referred to as a landing page that contains the additional information. The clicking or otherwise selecting of the link, the re-direction to the landing page, the landing page, and the additional information, for example, can each be tracked, and then the data associated with the tracking can be logged in data logs (such as the interaction data 416), and such logs may be communicated to the analytics server 118 for processing. Once processed into corresponding analytics data (such as the analytics data 414), such data can be input for determining ad impression availability.

Stream ads like the advertising items 222a, 222b, and 222c may be inserted into the stream of content, supplementing the sequence of related items, providing a more seamless experience for end users. Similar to content items, the advertising items may include textual or graphical content as well as other data, such as audio and video data or applications. Each advertising item 222a, 222b, and 222c may include text, graphics, other data, and a link to additional information. Clicking or otherwise selecting the link re-directs the browser on the client device to an electronic property referred to as a landing page. The clicking or otherwise selecting of the link, the re-direction to the landing page, the landing page, and the additional information, for example, can each be tracked, and then the data associated with the tracking can be logged in data logs (such as the interaction data 416), and such logs may be communicated to the analytics server 118 for processing. Once processed into corresponding analytics data (such as the analytics data 414), such data can be input for determining ad impression availability.

While the example streams 224a, 224b, and 224c are shown with a single visible advertising item 222a, 222b, and 222c, respectively, a number of advertising items may be included in a stream of items. Also, the advertising items may be slotted within the content, such as slotted the same for all users or slotted based on personalization or grouping, such as grouping by audience members or content. Adjustments of the slotting may be according to various dimensions and algorithms.

The various features described with respect to FIGS. 1-3 and interactions associated with such features can be tracked and logged in data logs and such logs may be communicated to the analytics server 118 for processing. Once processed into corresponding analytics data (such as the analytics data 414), such data can be input for determining ad impression availability. Also, these logs can be inputted for the building of sketches, such as building sketches per an audience segment, a segment combination, or at least part of a campaign. In such examples, these logs include user interaction data that can be associated with content category taxonomies through the building of sketches. These sketches can then be associated with audience segments, segment combinations, or at least parts of campaigns. These associations may be made by varying degrees of correlation. The strength of these correlations may affect the ad impression availability per correlated segment, correlated combination of segments, or correlated at least part of a campaign.

A sketch can be a category represented by a data structure or a complex value, such as a hash. A sketch can include limits, such as limit cones, and co-limits, such as co-limit cones. A model of the sketch in a category C can be a functor M:D→C, which takes each specified cone to a limit cone in C and each specified co-cone to a co-limit co-cone in C. See http://en.wikipedia.org/wiki/Sketch_(mathematics). Morphisms of such models can be natural transformations. See Id. Sketches can specify structures on the objects of a category. See Id. Sketches can form a category-theoretic analog to a logical concept of a theory and its models. See Id. Sketches can allow multisorted models and models in a category. See Id. An extensive definition or list of features of a sketch is beyond the scope of this application.

FIG. 4 illustrates a block diagram of the example information system of FIG. 1 (information system 100) interacting with an example system that can provide ad impression availability (availability server 116). For example, FIG. 4 illustrates the availability server 116 that enables ad impression availability, per audience segment, segment combination, or at least part of a campaign, derived from input, such as ad booking and analytics data. In an example, the provided audience availability can be adjusted by weights. The weights may represent breadth and/or popularity of a segment, a combination of segments, or at least part of an ad campaign.

As illustrated, aspects that are part of a system for generating and providing impression availability can be hosted in the availably server 116. However, any of the depicted aspects of the system, for generating and providing impression availability, may be hosted on a device external to the availability server 116. For example, the advertiser client device 401a and the audience client device 401b (such as the respective client devices 122, 124, 126, and 128) can host respective client-side applications 403a and 403b that can host or at least be associated with the respective scripts and/or applets 405a and 405b that can manage the selection, retrieval, and/or presentation of impression availability. Depending on the implementation, such impression availability can be presented in real time or with a noticeable processing delay. In an example, the presentation can be rendered through the respective client-side applications 403a and 403b.

In an example, the part of the availably server 116 that can provide impression availability to other devices is interfaces 402. Interfaces 402 can include communication interfaces, such as network ports and transceivers that include data formatting circuits. The data formatting circuits can format incoming and outgoing data to be compliant with various communication and data transfer protocols. The interfaces 402 may be communicatively coupled with any of the devices depicted in FIG. 1 through the network 120. As depicted in FIGS. 1 and 4, the network 120 communicatively couples the availability server with the other servers of FIGS. 1 and 4, and their respective databases. Any of these databases, depicted in FIG. 1 can store impression availability per audience segment, segment combination, or at least part of an ad campaign. Also, caches associated with any of the servers depicted in FIG. 1 can store impression availability so that such availability can be readily accessible and be provided in real time.

In addition to the interfaces 402, FIG. 4 depicts the availability server 116 hosting an impression availability calculator 404, a SCI calculator 406, and a NSCF calculator 408. As depicted, the interfaces 402 may be communicatively coupled to the availability calculator 404. The availability calculator 404 may be communicatively coupled to the SCI calculator 406. The SCI calculator 406 may be communicatively coupled to the NSCF calculator 408. The SCI calculator 406 and the NSCF calculator 408 may be communicatively coupled to the interfaces 402. These aforementioned communicative couplings provide channels for transferring data amongst parts of the information system 100.

Besides the channels between parts of the system 100, FIG. 4 also depicts data flow between the parts. For example, the availability server 116 can communicate impression availability data 410a and adjusted impression availability data 410b to other devices of FIGS. 1 and 4, such as the advertiser client device 401a. The impression availability data 410a and the adjusted impression availability data 410b can be a result a user requesting such data from a user interface of the advertiser client device 401a. A request from the advertiser client device 401a can include ad booking data 412. The advertiser client device 401a can communicate ad booking data 412 to other devices of FIGS. 1 and 4, such as the account server 102 and the availability server 116. Not depicted in FIG. 4, the advertiser client device 401a can also communicate ad booking data 412 to the ad server 108. The ad booking data 412 can be input for the determination of the impression availability data 410a and adjusted impression availability data 410b.

Ad booking data 412 can include information associated with the delivery of one or more online ads. Ad booking data 412 can include targeting data, such as selected audience segments, audience segment combinations, and at least parts of ad campaigns to be associated with the ad(s) for targeting the ad(s). For example, certain ad impressions can be associated with audience members sharing one or more demographics, psychographics, interests, or preferences (such as preferences for medium and devices to receive ads or content). Ad booking data 412 can include budget information, such as price cap per ad, a price cap per ad impression, price cap per ad click, price cap per targeted audience segment or combination of segments, a price cap per ad campaign, a daily, weekly, monthly, and/or yearly price cap, total funds in an advertiser's account, and the like. Booking data can include timing information, such as ad impression timing information. The timing information can include dayparting information. Ad impression timing information can include restrictions or preferences on times of the day, week, month, or year that ad impressions may be delivered. Ad booking data 412 can include ad formatting data, such as size, shape, pixilation, hertz, positioning, color scheme, file type, and data type of ads or ads per impression. Ad booking data 412 can also include strategies or routines that combine any one or more aspects of targeting data, budget information, timing information, and ad formatting data.

The analytics server 118 can communicate analytics data 414 to other devices of FIGS. 1 and 4, such as the availability server 116. The analytics data 414 can be determined at the analytics server and stored, for more immediate retrieval, in the analytics database 119. The analytics data 414 can be derived from interaction data 416 at the analytics server 118. The analytics data 414 can be input for the determination of the impression availability data 410a and adjusted impression availability data 410b.

Analytics data 414 can include ad impressions delivered. For example, the analytics data 414 can include a historical ad impressions delivery rate for a segment, a combination of segments, or at least a part of an ad campaign. Also, the analytics data 414 can include a historical amount of ad impressions delivered for a segment, a combination of segments, or at least a part of an ad campaign. Analytics data 414 can also include estimated analytics for future delivery of ad impressions for a segment, a combination of segments, or at least a part of an ad campaign. Analytics data 414 can also include historical and estimated future analytics on delivery of content for a segment, a combination of segments, or at least a part of an ad campaign. Analytics data 414 can also include historical and estimated future analytics on various types of ad booking data or various types of data related to the development, production, and delivery of ads or content, such as content including or associated with ads. Analytics data 414 can also include forecasted bids and forecasted pricing information. Analytics data can also include correlation data, such as data representing correlations between segments. Analytics data 414 can also include analytics on user interactions with content and ads online, such as analytics on click-through rate (CTR) per content item or ad item, per audience segment, segment combination, or at least part of an ad campaign.

The interaction data 416 can be identified and communicated from the audience client device 401b to the analytics server 118. Also, the interaction data 416, such as data including search engine inputs can be communicated from the audience client device 401b to the search engine server 106, and the search engine server, as a result of receiving the search engine inputs can generate and communicate a corresponding search query 420 for retrieval of ads and content from the ad server 108 and the content server 112. Also, the interaction data 416, such as data including URLs within hyperlinks can be communicated from the audience client device 401b to the ad server 108 and/or the content server 112, for getting corresponding ads and/or content 418. Although not depicted in FIG. 4, interaction data 416 can be identified and communicated from any of the devices of FIGS. 1 and 4. Additionally, ads and/or content 418 can be communicated to any of the devices of FIGS. 1 and 4 from any of the devices of FIGS. 1 and 4, such as servers 102, 106, 108, and 112.

Interaction data 416 can include CTR focused at varying levels of abstraction, including CTR per content item or ad item, per audience segment, segment combination, or at least part of an ad campaign. Interaction data 416 can include ad impression delivery rate focused at varying levels of abstraction, including ad impression delivery rate per ad, per audience segment, segment combination, or at least part of an ad campaign. Interaction data 416 can include dwell times, booked marked content, selected preferences, different refresh rates, such as page refresh rates. Interaction data 416 can include information on any type of web browsing behavior or estimated intent of a user. Interaction data 416 can include data representative of clicks, likes, page views, filling out forms or individual fields, and selections of streaming content, downloads, or uploads.

As depicted in FIG. 4, the ad booking data 412 and the analytics data 414 are received by the interfaces 402. The interfaces 402 can then further process the ad booking data 412 and the analytics data 414 for using such data as input for impression availability determinations at the availability calculator 404. The availability calculator 404, from these inputs can derive impression availability per audience segment and/or combination of audience segments, such as a combination of determined related segments, or per at least part of an ad campaign. This impression availability data 410a can be further manipulated by various factors, which results in adjusted availability data 410b. The various factors can include SCI and NSCF, and determinations of such factors can occur at respective calculators 406 and 408. In other words, the SCI and NSCF adjustments to the impression availability data 410a can occur at the respective calculators 406 and 408. Whether the impression availability has been adjusted or not, corresponding impression availability data 410a or 410b can be communicated from the interfaces 402 to the other devices of the information system 100, such as the advertiser client device 401a. The advertiser client device 401a, can then further process such data and render an impression availability for an advertiser selected audience segment, segment combination, or at least part of an ad campaign.

At the availability calculator 404, impression availability, per audience segment, segment combination, or at least part of a campaign, can be determined based on the ad booking data 412 and the analytics data 414. For example, the ad booking data 412 can provide a selected audience segment, segment combination, or at least part of a campaign, and the analytics data 414 can provide filtered impression logs including impressions associated with the selected audience segment, segment combination, or at least part of a campaign. The availability calculator 404 can also determine delivered impressions based on the ad booking data 412 and the analytics data 414, per audience segment, segment combination, or at least part of a campaign. Alternatively, the determined delivered impressions can be provided in the analytics data 414.

Also, in an example, per audience segment, segment combination, or at least part of a campaign, the availability calculator 404 can determine a qualified amount of impressions based on three inputs. First, a first audience segment, segment combination, or at least part of a campaign is based on the ad booking data 412. Second, this calculation can be based on a log of ad impressions delivered for the audience segment, segment combination, or at least part of a campaign. Third, this calculation is based on information on one or more other segments, segment combinations, or at least parts of campaigns (besides the first audience segment, segment combination, or at least part of a campaign), which also qualified for the ad impressions in the log but did not receive the ad impressions. Using the log and the information on the other one or more qualified segments, segment combinations, or at least parts of campaigns, the availability calculator 404 can generate a list of impressions for each audience member who was qualified for the one or more other qualified segments, segment combinations, or at least parts of campaigns. Using these lists, a qualified amount of impressions per the one or more qualified segments, segment combinations, or at least parts of campaigns can be determined. Also, the available amount of impressions for the first audience segment, segment combination, or at least part of a campaign can be determined according to the corresponding determined delivered impressions that can be determined directly from the log. After running these determinations for qualified amounts of impressions and available amounts of impressions over selected audience segments, segment combinations, or at least parts of campaigns, qualified amounts of impressions and available amounts of impression for each selected audience segment, selected segment combination, or selected at least part of a campaign can be identified. These identified amounts for a given audience segment, segment combination, or at least part of a campaign of the selected audience segments, segment combinations, or at least parts of campaigns can be used as inputs for determining SCI and NSCF.

The SCI calculator 406 can determine SCI per audience segment, segment combination, or at least part of a campaign, and adjust the corresponding impression availability according to the determined SCI. In an example, the SCI calculator 406 can determine SCI according to Formula 1. According to Formula 1, SCI may be closer to one hundred if a given audience segment is more general, such as a shared interest in sports. Where the SCI is closer to one, a given audience segment is more specific, such as a shared interest in a particular professional basketball team. As illustrated in Formula 1, SCI for a segment can be determined relative to all segments identified in a DMP. Max [Available Impressions/Qualified Impressions] represents an overall SCI for all segments identified in the DMP. Also, SCI for a given segment, segment combination, or at least part of an ad campaign can be determined relative to a respective target audience or ad campaign encompassing the given segment, the segment combination, or the at least part of an ad campaign.

$$S C I = 100 \times \frac{\frac{Available Impressions per Segment}{Qualified Impressions per Segment}}{Max [ \frac{Available Impressions}{Qualified Impressions} ]} \qquad ( 1 )$$

The NSCF calculator 408 can determine NSCF per audience segment, segment combination, or at least part of a campaign, and adjust the corresponding impression availability according to the determined NSCF. In an example, the NSCF calculator 408 can determine NSCF according to Formula 2. According to Formula 2, NSCF may be closer to one if a given audience segment is more specific. Where the NSCF is closer to zero, a given audience segment is more general.

$$N S C F = 1 - \frac{S C I}{100} \qquad ( 2 )$$

In an example, by adjusting ad impression availability by at least one of these two indices, impressions delivered can be adjusted to maximize impressions for a combination of niche and more general audiences. This can improve the sell through rate since niche impressions can be reserved for niche audience members, and more general ad impressions can be reserved for more general audience members. Since sell through rates can be optimized through such indices, ad impression pricing can also be increased.

For example, given a simplified ad marketplace with four audience members, U1, U2, U3, and U4, and given U1, U3, and U4 are interested in the NATIONAL BASKETBALL ASSOCIATION (NBA), and U2 is interested in the CHICAGO BULLS, which is also an inherent interest in the NBA; and given there are two advertisers: A1, who is bidding one dollar ($1) per impression targeted towards the NBA, and A2, who is bidding one dollar ($1) per impression targeted towards the CHICAGO BULLS. Also, given A1 has a daily spending cap of $3 and A2 has a daily cap of $1. Also, given the historical CTR for the NBA is better than that for the CHICAGO BULLS. Using daily spending cap, bid price per impression, and CTR as factors:
U1 may browse the web and qualify for an ad impression of A1, and A1 pays $1 for the impression;
U2 may browse the web and qualify for an ad impression of A1, and A1 pays $1 for the impression;
U3 may browse the web and qualify for an ad impression of A1, and A1 pays $1 for the impression; and
U4 may browse the web and qualify for an ad impression of A1, but A1 does not pay because its spending cap has been reached.
   In this first scenario, the service provider only generates $3 in revenue for three impressions made to U1, U2, and U3. However, there were four users browsing the web. Therefore, the sell through rate (STR) is 75%.

For example, with an adjusted process for providing ad impressions that considers niche and/or popularity of an audience segment, given the same ad marketplace with the four audience members, U1, U2, U3, and U4; and given the two advertisers, A1 and A2. Also, given A1 has a daily spending cap of $3 and A2 has a daily cap of $1. Also, given the historical CTR for the NBA is better than that for the CHICAGO BULLS. Using daily spending cap, bid price per impression, CTR, and niche and/or popularity of an audience segment as factors:
U1 may browse the web and qualify for an ad impression of A1, and A1 pays $1 for the impression;
U2 may browse the web and qualify for an ad impression of A2, and A2 pays $1 for the impression;
U3 may browse the web and qualify for an ad impression of A1, and A1 pays $1 for the impression; and
U4 may browse the web and qualify for an ad impression of A1, and A1 pays $1 for the impression.
   In this second scenario, the service provider generates $4 in revenue for four impressions made to U1, U2, U3, and U4. With four users browsing the web, there is now a STR of 100%. In this scenario, where niche and/or popularity of an audience are considered, the second STR is a 25% improvement over the first STR. Given this simplified example of how an ad marketplace can play out, it becomes apparent how adjusting impression availability by SCI or NSCF can improve generation of revenue for a service provider. Also, because STR is improved for the advertisers, pricing on impressions can also be increased which further increases the generation of revenue.

FIG. 500 is a block diagram of an example of an electronic device 500 that can request impression availability or provide interaction data, such as the advertiser client device 401a or the audience client device 401b, respectively. The electronic device 500 can include a central processing unit (CPU) 502, memory 510, a power supply 506, and input/output components, such as network interfaces 530 and input/output interfaces 540, and a communication bus 504 that connects the aforementioned elements of the electronic device. The network interfaces 530 can include a receiver and a transmitter (or a transceiver), and an antenna for wireless communications. The CPU 502 can be any type of data processing device, such as a central processing unit (CPU). Also, for example, the CPU 502 can be central processing logic; central processing logic may include hardware (such as circuits and/or microprocessors), firmware, software and/or combinations of each to perform functions or actions, and/or to cause a function or action from another component. Also, central processing logic may include a software controlled microprocessor, discrete logic such as an application specific integrated circuit (ASIC), a programmable/programmed logic device, memory device containing instructions, or the like, or combinational logic embodied in hardware. Also, logic may also be fully embodied as software.

The memory 510, which can include random access memory (RAM) 512 or read-only memory (ROM) 514, can be enabled by memory devices, such as a primary (directly accessible by the CPU) and/or a secondary (indirectly accessible by the CPU) storage device (such as flash memory, magnetic disk, optical disk).

The RAM 512 can store data and instructions defining an operating system 521, data storage 524, and applications 522, including the client-side application 403a or 403b and the script and/or applet 405a or 405b. The applications 522 may include hardware (such as circuits and/or microprocessors), firmware, software, or any combination thereof. Example content provided by an application, such as the client-side application 403a or 403b, may include text, images, audio, video, or the like, which may be processed in the form of physical signals, such as electrical signals, for example, or may be stored in memory, as physical states, for example.

The ROM 514 can include basic input/output system (BIOS) 515 of the electronic device 500. The power supply 506 contains power components, and facilitates supply and management of power to the electronic device 500. The input/output components can include various types of interfaces for facilitating communication between components of the electronic device 500, components of external devices (such as components of other devices of the information system 100), and end users. For example, such components can include a network card that is an integration of a receiver, a transmitter, and I/O interfaces, such as input/output interfaces 540. A network card, for example, can facilitate wired or wireless communication with other devices of a network. In cases of wireless communication, an antenna can facilitate such communication. The I/O components, such as I/O interfaces 540, can include user interfaces such as monitors, keyboards, touchscreens, microphones, and speakers. Further, some of the I/O components, such as I/O interfaces 540, and the bus 504 can facilitate communication between components of the electronic device 500, and can ease processing performed by the CPU 502.

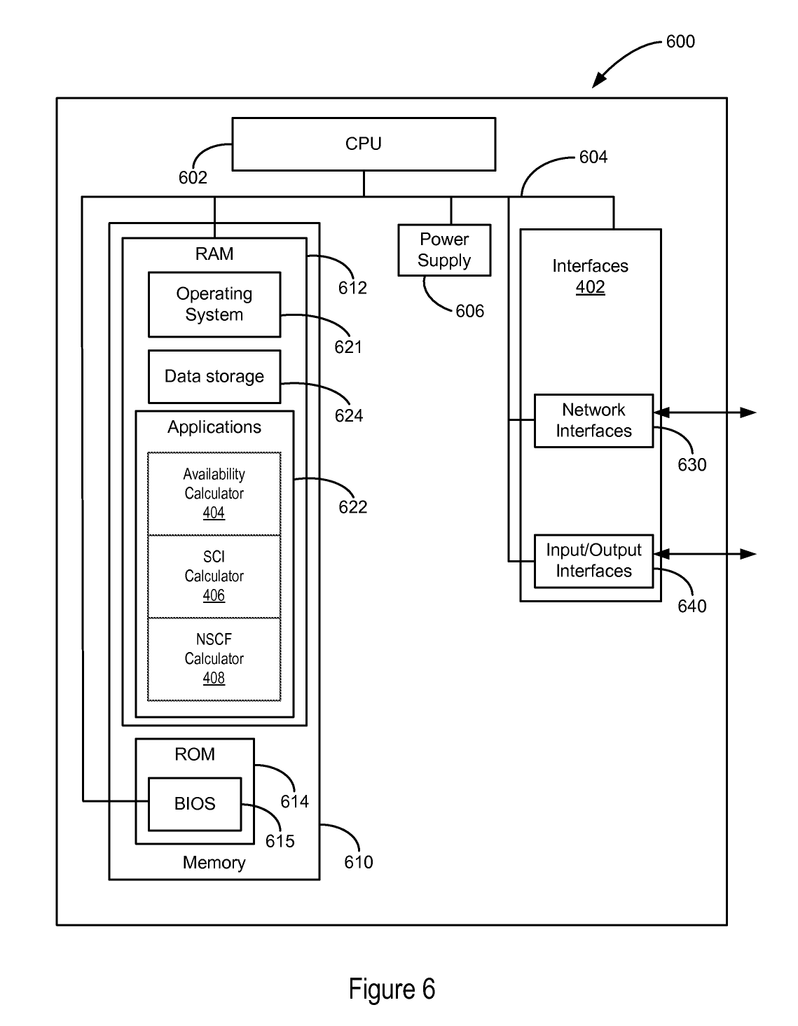

FIG. 6 is a block diagram of an example of an electronic device 600 that can generate impression availability and can respond to requests for the impression availability, such as the availability server 116. The electronic device 600 can include a CPU 602, memory 610, a power supply 606, and input/output components, such as network interfaces 630 and input/output interfaces 640, and a communication bus 604 that connects the aforementioned elements of the electronic device. The network interfaces 630 can include a receiver and a transmitter (or a transceiver), and an antenna for wireless communications. The CPU 602 can be any type of data processing device, such as a central processing unit (CPU). Also, for example, the CPU 602 can be central processing logic.

The memory 610, which can include random access memory (RAM) 612 or read-only memory (ROM) 614, can be enabled by memory devices. The RAM 612 can store data and instructions defining an operating system 621, data storage 624, and applications 622, including the availability calculator 404, the SCI calculator 406, and the NSCF calculator 408. The applications 622 may include hardware (such as circuits and/or microprocessors), firmware, software, or any combination thereof. The ROM 614 can include basic input/output system (BIOS) 615 of the electronic device 600.

The power supply 606 contains power components, and facilitates supply and management of power to the electronic device 600. The input/output components can include the interfaces 402 for facilitating communication between any components of the electronic device 600, components of external devices (such as components of other devices of the information system 100), and end users. For example, such components can include a network card that is an integration of a receiver, a transmitter, and I/O interfaces, such as input/output interfaces 640. The I/O components, such as I/O interfaces 640, can include user interfaces such as monitors, keyboards, touchscreens, microphones, and speakers. Further, some of the I/O components, such as I/O interfaces 640, and the bus 604 can facilitate communication between components of the electronic device 600, and can ease processing performed by the CPU 602.

Where the electronic device 600 is a server, it can include a computing device that is capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

1. A system stored in a non-transitory medium executable by a processor, comprising:
a communications interface configured to receive online ad booking information and online ad analytics data, the online booking information and the online ad analytics data corresponding to at least one of an audience segment, a combination of audience segments, or at least part of an ad campaign;
an availability calculator communicatively coupled to the communications interface, the availability calculator configured to determine ad impression availability according to the online ad booking information and the online ad analytics data, the ad impression availability including at least one of an ad impressions available for delivery rate or an estimated amount of ad impressions available for a life of the at least one of the audience segment, the combination of audience segments, or the at least part of an ad campaign; and
an availability adjuster communicatively coupled to the availability calculator, the availability adjuster configured to adjust the ad impression availability according to a popularity score or a niche score of the at least one of the audience segment, the combination of audience segments, or the at least part of an ad campaign.

2. The system of claim 1, wherein the availability adjuster is configured to calculate a segment contention index (“SCI”) and adjust the ad impression availability according to the SCI.

3. The system of claim 1, wherein the availability adjuster is configured to calculate a niche segment correction factor (“NSCF”) index and adjust the ad impression availability according to the NSCF index.

4. The system of claim 1, wherein the audience segment includes a group of ad audience members that share one or more demographics, psychographics, interests, or preferences.

5. The system of claim 4, wherein the one or more preferences includes at least one of preferred device or medium to receive ads or content, preferred telecommunications carrier, and preferred formatting or timing of certain content.

6. The system of claim 1, wherein the combination of audience segments includes a combination of related audience segments that occurs due to correlations between the related audience segments exceeding a correlation threshold.

7. The system of claim 1, wherein the ad campaign includes a plan for delivering ads.

8. The system of claim 1, wherein the ad campaign includes a life, wherein the life can include various time periods of various strategies for ad delivery, and wherein a time period of the various time periods includes ad targeting of different audience segments than another time period of the various time periods.

9. A method comprising:
receiving, at a communications interface, online ad booking information and online ad analytics data, the online booking information and the online ad analytics data corresponding to one or more audience segments receiving ad impressions;
determining, at availability calculator hardware communicatively coupled to the communications interface, ad impression availability according to the online ad booking information and the online ad analytics data, the ad impression availability including at least one of an ad impressions available for delivery rate or an estimated amount of ad impressions available for a life of the one or more audience segments; and
adjusting, at availability adjuster hardware communicatively coupled to the availability calculator hardware, the ad impression availability according to popularity or niche of the one or more audience segments.

10. The method of claim 9, further comprising:
calculating segment contention index (“SCI”); and
adjusting the ad impression availability according to the SCI.

11. The method of claim 9, further comprising:
calculating niche segment correction factor (“NSCF”) index; and
adjusting the ad impression availability according to the NSCF index.

12. The method of claim 10, wherein SCI is calculated according to the following formula:
$$S C I = 100 \times \frac{\frac{Available Impressions per Segment}{Qualified Impressions per Segment}}{Max [ \frac{Available Impressions}{Qualified Impressions} ]} ,$$
wherein available impressions per segment is an amount of ad impressions available for delivery per segment for a period of time or a life of that segment,
wherein qualified impressions per segment is an amount of ad impressions qualified for delivery per segment for a period of time or a life of that segment, but not necessarily available for delivery,
wherein
$$Max [ \frac{Available Impressions}{Qualified Impressions} ] is \frac{Available Impressions}{Qualified Impressions}$$
for all segments identified by a respective data management platform.

13. The method of claim 11, wherein NSCF index is calculated according to the following formula:
$$N S C F = 1 - \frac{S C I}{100}$$

14. The method of claim 12, wherein NSCF index is calculated according to the following formula:
$$N S C F = 1 - \frac{S C I}{100} .$$

15. The method of claim 12, comprising calculating the qualified impressions per segment according to the online ad booking information and the online ad analytics data corresponding to that segment and according to information on one or more other segments that also qualified for similar ad impressions in the online ad booking information and the online ad analytics data, but did not receive the ad impressions.

16. A system, comprising:
a means for determining ad impression availability according to online ad booking information and online ad analytics data, the ad impression availability including at least one of an ad impressions available for delivery rate or an estimated amount of ad impressions available for a life of one or more audience segments receiving ad impressions; and
a means for adjusting the ad impression availability according to at least one of a niche segment correction factor (“NSCF”) index or a segment contention index (“SCI”).

17. The system of claim 16, wherein SCI is determined according to the following formula:
$$S C I = 100 \times \frac{\frac{Available Impressions per Segment}{Qualified Impressions per Segment}}{Max [ \frac{Available Impressions}{Qualified Impressions} ]} ,$$
wherein available impressions per segment is an amount of ad impressions available for delivery per segment for a period of time or a life of that segment,
wherein qualified impressions per segment is an amount of ad impressions qualified for delivery per segment for a period of time or a life of that segment, but not necessarily available for delivery,
wherein
$$Max [ \frac{Available Impressions}{Qualified Impressions} ] is \frac{Available Impressions}{Qualified Impressions}$$
for all segments identified by a respective data management platform.

18. The system of claim 16, wherein NSCF index is determined according to the following formula:
$$N S C F = 1 - \frac{S C I}{100} .$$

19. The system of claim 17, wherein NSCF index is determined according to the following formula:
$$N S C F = 1 - \frac{S C I}{100} .$$

20. The system of claim 17, comprising calculating the qualified impressions per segment according to the online ad booking information and the online ad analytics data corresponding to that segment and according to information on one or more other segments that also qualified for similar ad impressions in the online ad booking information and the online ad analytics data, but did not receive the ad impressions.
